(19) United States
(12) Patent Application Publication
(10) Pub. No.: US 2008/0242160 A1
(43) Pub. Date: Oct. 2, 2008

(54) Insert Designed to Mounted in an Element, for Fixing and Electrically Contacting an Electrically Connecting Socket

(76) Inventors: Jerome Machet, Couddes (FR); Benoit Gasselin, Blois (FR)

Correspondence Address: GREENBLUM & BERNSTEIN, P.L.C., 1950 ROLAND CLARKE PLACE, RESTON, VA, 20191, US

(21) Appl. No.: 12/065,817

(22) PCT Filed: Sep. 4, 2006
(86) PCT No.: PCT/FR2006/002026

§ 371 Date: May 27, 2008

(30) Foreign Application Priority Data
Sep. 6, 2005 (FR) 0509080

(51) Int. Cl. H01R 4/34; H01R 4/30

(52) U.S. Cl. 439/805; 439/801

(57) ABSTRACT

The invention concerns an insert designed to be mounted in a calibrated hole (2) of an element (1) for fixing and electrically contacting an electrically connecting socket, consisting of an electrically conductive ring (3) having a sleeve (3a) which is secured to a saddle (3b) and of a screw (4) which is provided with a shaft (4a) designed to be inserted into the ring (3) and with a head (4b) facilitating its being screwed and enabling further the socket to be clamped (5), between itself and the saddle (3b) of the ring whereof the sleeve (3a) has been previously inserted into said hole (2) of the element (1). Said insert is particularly characterized in that the sleeve (3a) and the saddle (3b) of the ring (3) do not comprise a slot and have a smooth inner surface and in that the screw is a self-threading screw (4) dimensioned to be able both to thread the inner surface of the sleeve (3a) of the ring (3) while deforming by expansion the material constituting said sleeve whereof the outer surface can thus be urged to be forcefully pressed on the inner wall of the hole (2) of the element (1).

The invention relates to an insert intended to be mounted in an element, for attachment and electrical contact of an electrical connection plug, and in particular in the web of a rail of a railroad track.

The invention also relates to a method for installing such an insert. It is known to force a tie plug with a frustoconical head equipped with an externally-threaded rod into a piercing of the web of a rail, with the plug being held on said rod, for example by means of a nut.

Document DE-19847361 A1 also mentions a device in the form of an insert intended to be mounted in a calibrated hole of an element for the attachment and electrical contact of an electrical connection plug, which is constituted, on the one hand, by an electrically conductive ring having a sleeve that is integral with a collar and, on the other hand, a screw that is equipped with a rod intended to be inserted into the ring and a head facilitating its screwing and also making it possible to clasp the plug between itself and the collar of the ring of which the sleeve has previously been inserted into said hole of the element.

However, in such a device, the sleeve has longitudinal slots for forming a plurality of contact flanges, while the screw is screwed into a threading of the collar, which is particularly: thick for this purpose, and an extension of the screw makes it possible to obtain a resilient separation of said flanges.

This device with resilient deformation has in particular the disadvantage of reduced electrical conduction of the sleeve in the calibrated hole due to the slots, even if, as described in this document, a contact part mounted in the calibrated hole is added.

For the same reasons, such a device does not provide good tightness, which leads to risks of corrosion. These risks constitute a major problem for a device subjected to adverse weather, as is the case in the aforementioned application.

In addition, document EP-0 507 259 A1 describes an insert and recommends a plastic deformation of a ring by means of a frustoconical head of a tie plug, with said ring having a bore that is also frustoconical.

Owing to the deformation of the material, the ring does not need to be cracked as in the previous case, resulting in the advantages of good electrical contact and tightness.

Even if such an insert is satisfactory, it nevertheless requires a relatively time-consuming implementation and sophisticated installation equipment.

For this reason, the inventors envisaged a new insert that is easy to install, as in document DE-19847361 A1, but electrically effective, with good electrical conduction and good tightness, as in document EP-0 507 259 A1.

The insert according to the invention comprises, as described above with regard to the aforementioned document DE-19847361 A1, on the one hand, an electrically conductive ring having a sleeve that is integral with a collar, and, on the other hand, a screw equipped with a rod and a head, but that is, by contrast, especially remarkable in that the sleeve and the collar of the ring do not have any slot and have a smooth internal surface, and in that the screw is a thread-cutting screw sized so as to be capable both of threading the internal surface of the sleeve of the ring while deforming, by expansion, the material constituting said sleeve of which the external surface can thus be applied forcefully on the internal wall of the hole of the element.

The inventors were able to find a new use of a thread-cutting screw that, not only classically threads a bore as, for example, in document DE-4404057 A1, but that simultaneously plastically deforms the ring, which cannot be done with a classic screw cooperating with a pre-formed threading.

In document DE-4404057 A1, for example, the screw used resiliently deforms a cracked part by its frustoconical shape, whereas the use of a thread-cutting screw in this device does not cause any additional deformation and is recommended only to classically avoid the preliminary formation of a threading. For example, between the plug and the head of the screw, at least one washer is inserted.

To ensure good electrical contact and a good attachment, the internal diameter of the sleeve of the ring has a value below that recommended by the manufacturer of the thread-cutting screw for a classical use thereof, and, in particular, the internal diameter of the sleeve of the ring is smaller than said recommended size by around 10 to 15%.

It is known, for example, for a thread-cutting screw with a diameter of 10 mm±0.1, to use, for a classical use in an object with a hardness of 40 to 50 da N/mm², a piercing of 9.3 mm±0.1.

Advantageously, the sleeve of the ring has an internal diameter that is smaller than the diameter of the thread-cutting screw by around 16 to 22% and, by way of example, the thread-cutting screw has a diameter of around 10 mm±0.1, and the sleeve of the ring has an internal diameter of around 8.10 mm±0.1, while the hardness of the material constituting the sleeve of the ring is within a range from 20 to 30 da N/mm². The internal diameter of the sleeve and the hardness thereof are obviously chosen so that the force exerted by the thread-cutting screw causes the desired external diametric expansion of said sleeve.

According to an embodiment, the inlet of the ring on its collar side is chamfered to form an outward flare so as to provide better guiding of the thread-cutting screw, and, advantageously, the collar of the ring has means for engaging a tool so as to make it easier to maintain its rotation by said tool.

The thread-cutting screw is preferably of the multi-lobed type, and is in particular tri-lobed.

According to an embodiment, the internal surface of the sleeve of the ring is cylindrical, or at least partially slightly frustoconical.

In particular, for an attachment in a through-hole of the element, the sleeve of the ring is open at both of its ends.

In addition, the sleeve of the ring has a circular or polygonal external cross-section intended to cooperate with a hole of the element having a corresponding shape.

According to an embodiment, the thread-cutting screw has a groove in the vicinity of its head, intended to receive the plug to be connected, which is inserted on the rod of the thread-cutting screw by screwing by means of an internal threading with which the plug is provided for this purpose, or an internal threading produced by the thread-cutting screw itself.

The invention also relates to a preferred, but not obligatory, use of said insert, which is advantageously used for the electrical contact of a conductor connected to the plug with a rail of a railroad track of which the web constitutes the element in which the insert is mounted.

The invention also relates to a method for installing such an insert, which consists of:
positioning the ring of the insert by inserting its sleeve into the calibrated hole previously formed in the element to be equipped,

placing the plug on the thread-cutting screw, in particular by screwing,

threading the internal surface of the sleeve of the ring by screwing the thread-cutting screw while holding the ring in the hole of the element,

deforming the sleeve of the ring by expansion during the threading thereof,

providing the electrical contact of the plug by clamping the thread-cutting screw of which the head clamps said plug, directly or not, between itself and the collar of the ring.

The invention can be better understood on reading the following description, which refers to the appended drawings in which:

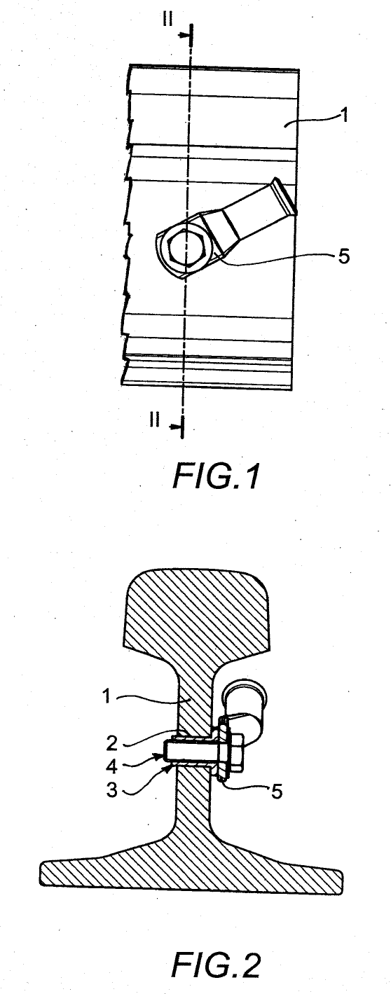

FIG. 1 shows an elevated view of an insert according to the invention, installed in the web of a railroad track,

FIG. 2 is a cross-section according to II-II of FIG. 1 (the cross-section of the screw is not shown for the sake of clarity),

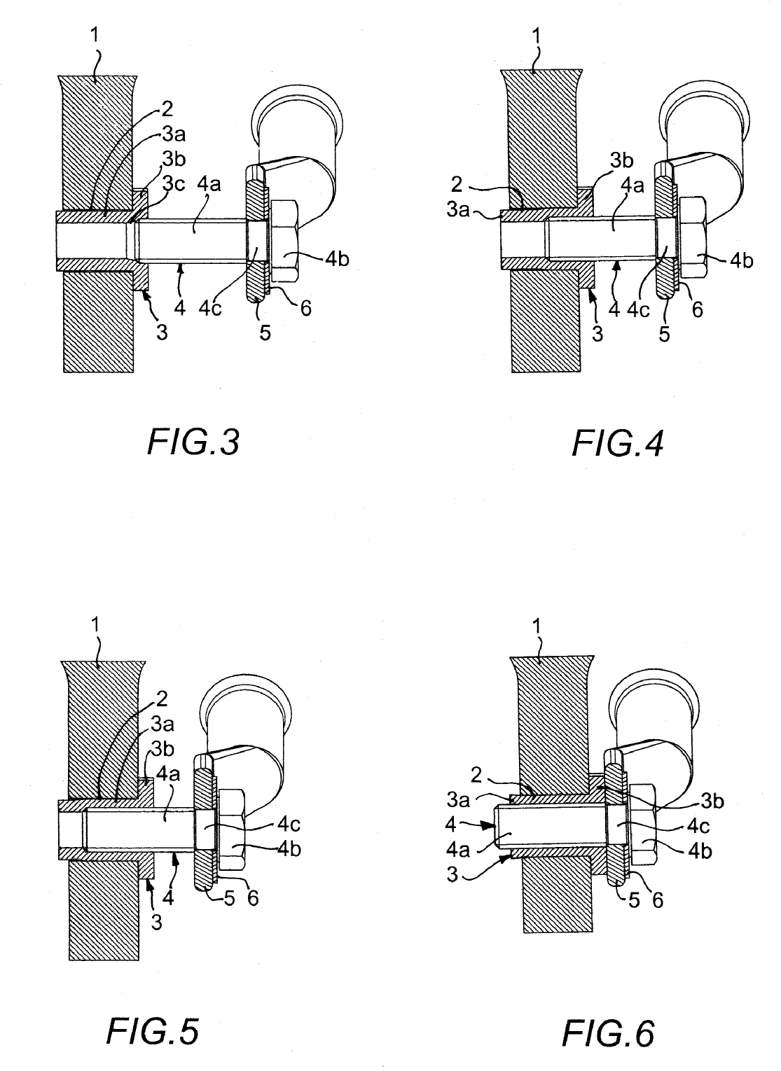

FIGS. 3 to 6 show cross-sections (the cross-section of the screw is not shown for the sake of clarity) of the series of phases of installing the insert in an element such as a web of a rail of a railroad track shown in FIGS. 1 and 2.

In the example shown in FIGS. 1 and 2, the insert according to the invention is placed in the web of a rail 1 of a railroad track.

However, as mentioned above, it is clear that the insert according to the invention can be used in any other element or electrically-conductive support (including carbon composites), equipped with a calibrated through-hole 2 of the element, as in the example shown, or a blind hole.

Consequently, in FIGS. 3 to 6, reference 1 is used to show the element that can be a portion of the rail 1 of FIGS. 1 and 2 or another element.

The figures show an insert that is constituted, on the one hand, by an electrically-conductive ring 3, made of copper or aluminum, for example, comprising a sleeve 3a integral with a collar 3b, wherein the ring is preferably in a single piece, and, on the other hand, by a screw 4 equipped with a rod 4a and a head 4b, which will be described below.

The sleeve 3a has a smooth internal cylindrical surface and an external cross-section, in this case circular (it could by polygonal).

The insert (3, 4) is intended to attach, ensuring good electrical contact, an electrical connection plug 5, itself connected in a known manner and not shown, to a conductor or the like, for the purpose of grounding, for example.

In the example shown, the sleeve 3a is longer than the hole 2 of the rail 1 so that after having been inserted into said hole, said sleeve projects slightly from the side of the element opposite the side in which it was inserted. The external diameter of the sleeve and the internal diameter of the hole are of course adjusted with respect to one another.

It is also noted that, in this example, the sleeve 3a is open at its two ends and that, at its end facing the collar 3b, it has an outwardly-flared chamfer 3c.

The screw 4 is of the thread-cutting type or, depending on the particular name, self-threading and still more specifically, of the tri-lobed type.

The diameter of the rod 4a of the screw 4 with respect to the internal diameter of the sleeve 3a, as for the material used to produce the ring 3, are chosen so that the thread-cutting screw 4, when it is screwed into said ring, threads it while deforming it (deformation of the material) so as to cause an enlargement of its external diameter.

In addition, before the screwing of the screw 4 begins, as shown in FIG. 1 and in this embodiment, the threading of said screw is used to install the plug 5, which is either provided for this purpose with a conjugated internal threading, or is advantageously made of a suitable material and with an internal diameter suitable for being threaded by said screw 4 itself, while a groove 4c is provided under the head 4b of the screw in order to receive said plug 5 at the end of the screwing, thus making it practically impossible to lose.

In a preliminary and optional step, it is possible to provide at least one anti-friction washer 6 between the head 4b of the screw and the plug 5.

For example, the screw has a diameter of around 10 mm±0.1 and the sleeve has an internal diameter of around 8.10 mm±0.1, and more generally, the internal diameter of the sleeve is smaller by around 16 to 22% than the diameter of the thread-cutting screw, i.e. around 10 to 15% smaller than the diameter recommended by the manufacturer of the thread-cutting screw for a conventional use.

Also by way of example, the hardness of the material used for the ring is around 20 to 30 da N/mm².

The inventors indeed found that by choosing the correct diameters and the correct material, it was possible to thread and simultaneously deform the ring. Starting with FIG. 1, which shows the start of the screwing of the screw 4 into the ring 3, facilitated at the beginning by the chamfer 3c of the ring, which provides guidance of the screw, the screwing is continued, and, as shown in FIGS. 4 and 5, the ring is progressively deformed and expands so as to be forcefully applied on the internal wall of the hole 2 of the rail 1.

In addition, over the course of this deformation obtained by the thread-cutting screw, the thickness of the sleeve 3a decreases and, at the end of the screwing (FIG. 6), when the rod 4a leads to the other side of the rail 1, the rail pushes the material of the ring axially and radially outwardly as shown in said FIG. 6. In this way, perfect conduction of the electrical connection thus produced is achieved while reinforcing the holding of the ring 3 in the hole 2.

To facilitate the maintenance of the rotation of the ring 3 during the screwing of the screw 4, the collar 3b has, on its periphery, striations or at least two clipped-off sections or a polygonal shape so as to be capable of being held in rotation by a tool such as a planar key, with the understanding that, as the screw progresses, the screwing torque increases and the ring is quickly locked without the need to be held any longer.

To ensure close contact of the plug 5 on the collar 3b, a predefined clamping torque (for example 40N/m) is applied, which can easily be obtained by means of a dynamometric key.

By describing the insert according to the invention, we have simultaneously described the installment method as mentioned above and in the claims.

It is understood that such an insert can be placed simply in a hole, optionally a blind hole, without it being necessary to have access to the two sides of the element, while ensuring excellent electrical contact and a reversible assembly of the screw in the ring. Moreover, good resistance to vibrations and loosening is obtained.

Numerous applications are possible aside from that described above by way of example, and in particular in the field of grounding and protection of electrical or electronic units.

1. Insert intended to be mounted in a calibrated hole (2) of an element (1) for attachment and electrical contact of an electrical connection plug (5), which is formed, on the one hand, by an electrically conductive ring (3) having a sleeve (3a) that is integral with a collar (3b), and, on the other hand, a screw (4) equipped with a rod (4a) intended to be inserted into the ring (3) and a head (4b) facilitating the screwing thereof and also making it possible to clamp the plug (5) between itself and the collar (3b) of the ring of which the sleeve (3a) has previously been inserted into said hole (2) of the element (1), characterized in that the sleeve (3a) and the collar (3b) of the ring (3) do not have any slot, and they have a smooth internal surface, and in that the screw is a thread-cutting screw (4) sized so as to be capable both of threading the internal surface of the sleeve (3a) of the ring (3) while deforming, by expansion, the material constituting said sleeve of which the external surface can thus be applied forcefully on the internal wall of the hole (2) of the element (1).

2. Insert according to claim 1, characterized in that, between the plug (5) and the head (4b) of the screw, at least one washer (6) is inserted.

3. Insert according to claim 1, characterized in that the internal diameter of the sleeve (3a) of the ring has a value below that recommended by the manufacturer of the thread-cutting screw (4) for a conventional use thereof.

4. Insert according to claim 3, characterized in that the internal diameter of the sleeve (3a) of the ring is smaller than said recommended size by around 10 to 15%.

5. Insert according to claim 1, characterized in that the sleeve (3a) of the ring has an internal diameter that is smaller than the diameter of the thread-cutting screw (4) by around 16 to 22%.

6. Insert according to claim 1, characterized in that the thread-cutting screw (4) has a diameter of around 10 mm 0.1, and the sleeve (3a) of the ring has an internal diameter of around 8.10 mm 0.1.

7. Insert according to claim 1, characterized in that the hardness of the material constituting the sleeve (3a) of the ring is within a range from 20 to 30 da N/mm².

8. Insert according to claim 1, characterized in that the inlet of the ring (3) on the side of its collar (3b) is chamfered to form an outward flare so as to provide better guiding of the thread-cutting screw (4).

9. Insert according to claim 1, characterized in that the collar (3b) of the ring has means for engaging a tool so as to make it easier to maintain its rotation by said tool.

10. Insert according to claim 1, characterized in that the thread-cutting screw (4) is of the multi-lobed type, and is in particular tri-lobed.

11. Insert according to claim 1, characterized in that the internal surface of the sleeve (3a) of the ring is cylindrical, or at least partially slightly frustoconical.

12. Insert according to claim 1,
characterized in that the sleeve (3a) of the ring is open at both of its ends.

13. Insert according to claim 1, characterized in that the sleeve (3a) of the ring has a circular or polygonal external cross-section intended to cooperate with a hole (2) of the element having a corresponding shape.

14. Insert according to claim 1, characterized in that the thread-cutting screw (4) has a groove (4c) in the vicinity of its head (4b), intended to receive the plug (5) to be connected, which is inserted on the rod (4a) of the thread-cutting screw by screwing by means of an internal threading with which the plug is provided for this purpose, or an internal threading produced by the thread-cutting screw (4) itself.

15. Insert according to claim 1, characterized in that it is used for the electrical contact of a conductor connected to the plug (5) with a rail (1) of a railroad track of which the web constitutes the element in which the insert is mounted.

16. Method for installing such an insert according to claim 1 in a calibrated hole (2) of an element (1) for attachment and electrical contact of an electrical connection plug (5), characterized in that it consists of:
positioning the ring (3) of the insert by inserting its sleeve (3a) into a calibrated hole (2) previously formed in the element (1) to be equipped,
placing the plug (5) on the thread-cutting screw (4), in particular by screwing,
threading the internal surface of the sleeve (3a) of the ring by screwing the thread-cutting screw (4) while holding the ring (3) in the hole (2) of the element,
deforming the sleeve (3a) of the ring by expansion during the threading thereof,
providing the electrical contact of the plug (5) by clamping the thread-cutting screw (4) of which the head (4b) clamps said plug (5), directly or not, between itself and the collar (3b) of the ring.
